(19) United States
(12) Patent Application Publication
(10) Pub. No.: US 2005/0075928 A1
(43) Pub. Date: Apr. 7, 2005

(54) Methods and apparatus for promoting sales by reducing the purchase price at the time of sale for randomly selected products or purchasers

(75) Inventor: Dan Ariely, Cambridge, MA (US)

Correspondence Address: CHARLES G. CALL, 68 HORSE POND ROAD, WEST YARMOUTH, MA, 02673-2516, US

(73) Assignee: Massachusetts Institue of Technology

(21) Appl. No.: 10/677,946

(22) Filed: Oct. 2, 2003

(51) Int. Cl. G06F 17/60

(52) U.S. Cl. 705/14

(57) ABSTRACT

Methods and apparatus for executing sales transactions in which products or services are offered for sale either at an established normal price or at one or more reduced prices charged in the event a chance event occurs. The chance event may select particular purchasers who are to be charged the reduced prices, or may select particular products or services for which reduced prices are charged. Potential purchasers are advised prior to the time of sale that they have a chance to receive products or services they elect to purchase at reduced prices. Preferably, the purchaser is given the opportunity to receive products they elect to purchase at no charge if the chance event occurs.

### FIELD OF THE INVENTION

This invention relates to methods and apparatus for conducting sales transactions.

### BACKGROUND AND SUMMARY OF THE INVENTION

Prospective purchasers are often provided with incentives to buy particular goods or services, to use particular payment methods such as branded credit cards, or to make those purchases from a particular vendor. Such discounts are offered to increase the number of purchasers transacting with a vendor, the size of their shopping basket, or to manage inventory.

It is an object of the present invention to provide more effective methods and apparatus for promoting goods and services.

In its preferred embodiments, the present invention take the form of methods and apparatus for promoting one or more products or services by offering the selected goods or services for sale at a predetermined normal price with probability l-p, which is referred to here as a negative outcome, and at a second predetermined reduced price with probability p, which is referred to here as a positive outcome. The process of generating the random outcome from the predetermined distribution is called here the “selection process,” and it may be applied to each purchaser, to each product, or to any target of promotion—determining the price of the products or services, or for the purchasers.

As contemplated by the invention, the reduced price is preferably zero; that is, the purchaser has the opportunity to obtain the goods or services selected at no charge if the selection process results in a positive outcome (positive is defined here as positive for the purchaser). The selection process used to select the particular event (purchaser, product, or service) that will be free preferably occurs before the time of checkout, allowing purchasers to be informed in advance that they may have already been selected to receive the goods or services they elect to purchase at no charge. This can be applied to the entire shopping basket, to a selected few products, or to randomly selected products. Preferably, the particular goods or services, which may, if the chance event occurs, be provided free of charge are identified in advance.

The invention may be advantageously implemented in a computer-controlled point-of-sale or online system wherein the selection process is performed by generating a random or pseudo-random number and determining whether or not the generated number satisfies a specified criteria. Such systems include, among others, electronic commerce systems, credit cards, and electronic tellers. The computer generated chance event may be used to determine whether a particular purchasers, products, or services, which will be subject to the selection process and the possibility of price reduction.

The invention may be embodied in a method for promoting a product or service in which purchasers are informed that goods or services which they elect to purchase may be obtained at no charge, or at a discount, if the selection process results in a positive outcome.

At or before the time the purchaser purchases identified goods or services, the system may perform a random or pseudo-random process to produce the outcome of the selection process. After the purchaser makes a commitment to make the purchase, he or she is then charged either the normal price if the outcome of the selection process is negative, or a specified reduced price if the outcome of the selection process is-positive. The system preferably gives the merchant the ability to determine both the reduced amount to be charged when the outcome of the selection process is positive and p, which is the probability of a positive outcome from the selection process, thereby establishing both the amount of the discount and the odds of its being applied to the sale. In the preferred application, both the amount of the possible discount and the probability of its occurrence are included in the information provided to prospective purchasers before purchases occur.

The purchaser may be given the option, preferably at the time the purchase is made, of electing to pay either a fixed amount or to pay a variable amount which is contingent on the outcome of the selection process. For example, the purchaser may be given the option of receiving a fixed discount of 10%, or to pay full price with a one-in-ten chance of getting the purchased item(s) for nothing. At the time of the checkout, if the purchaser wants to be considered for this probabilistic promotion, he or she will be preferably informed, and will need to agree, that product returns are not possible (or at least be informed of and agree to the conditions under which returns will be permitted). If a commitment for no-returns was not made, the purchaser could continuously return an item until he or she gets the discount. For some products, returns present few problems (e.g. grocery items), but if customers do not wish to agree not to return a purchase, they may be given the opportunity to get a fixed discount without any constraints on the return policy.

### BRIEF DESCRIPTION OF THE DRAWINGS

In the detailed description, which follows, frequent reference will be made to the attached drawings, in which:

FIG. 1 is a block diagram of an online sales system, which may be adapted to use the invention;

FIG. 2 is a flow chart showing a sequence of steps employed in practicing on example embodiment of the invention; and

FIG. 3 is a graphical depiction of a dialog box display used to set the operating parameters which determine the nature and probability of discounts applied in one embodiment of the invention.

### DETAILED DESCRIPTION

The methods and apparatus embodying the invention typically take the form of an A online or point-of-sale system for executing sales transactions in which products or services are offered for sale either at an established normal price or at reduced price in the event that the selection process results in a positive outcome at the time of sale.

For example, a television set might be offered for sale at the established normal price of $299 but with a selection process with p=0.05. Each purchaser who elects to purchase the television set has a probability of p=0.05 to receive it free of charge. This type of discount, which in expected value is equivalent to giving away one of every twenty products is financially equivalent, from the seller's standpoint, to selling all products at a 5% discount. To most buyers, however, the one-in-twenty chance to receive a free product is more attractive than a 5% discount. As a consequence, the methods and apparatus contemplated by the invention more effectively promote the retail outlet, products, or services than conventional discounting.

An online retail sales system, which can be readily adapted to use the invention is shown in FIG. 1. Purchasers use web browser as seen at 101 and 103 to view web page presentations via the Internet 105 from a web server 111 operated by the retail merchant. The web server 111 transmits web pages to the purchasers' web browsers, and receives submissions from the purchasers during interactive sales sessions. An application server 113 builds web pages in response to submissions from the purchasers utilizing data, including inventory data and product descriptions, stored in a relational database server 115.

The servers 111, 113 and 115 provide a retail sales online storefront 130. The online storefront 130 may be implemented using existing online retail sales software, such as “iStore,” a storefront application available from Oracle Corporation, Redwood Shores, Calif., which employs the Oracle 8 relational database management system and Oracle application server. iStore allows merchants to choose and customize the store checkout process in order to provide purchasers with a unique shopping experience. Merchants can choose from numerous check out options to provide configurable buy- button behavior, single or multiple product add to a shopping cart, shopping lists for repeat purchase items, saved and shared shopping carts for purchases which involve multiple people and/or approval and express checkout.

The invention may also be employed to provide “probabilistic pricing” for goods and services purchased in a “bricks and mortar” store in which point of sale terminals are coupled to an inventory control system. As an example, Microsoft's HeadQuarters system that provides integrated point-of-sale and in-store functions that trade data with Microsoft's Retail Management System Store Operations. This system includes the ability to describe new products and services, set pricing and discounts, generate purchase orders and direct inter-store inventory transfer from the head office, automatic uploading of stores' inventory movement, financial transactions and sales data stored in a Microsoft SQL Server™.

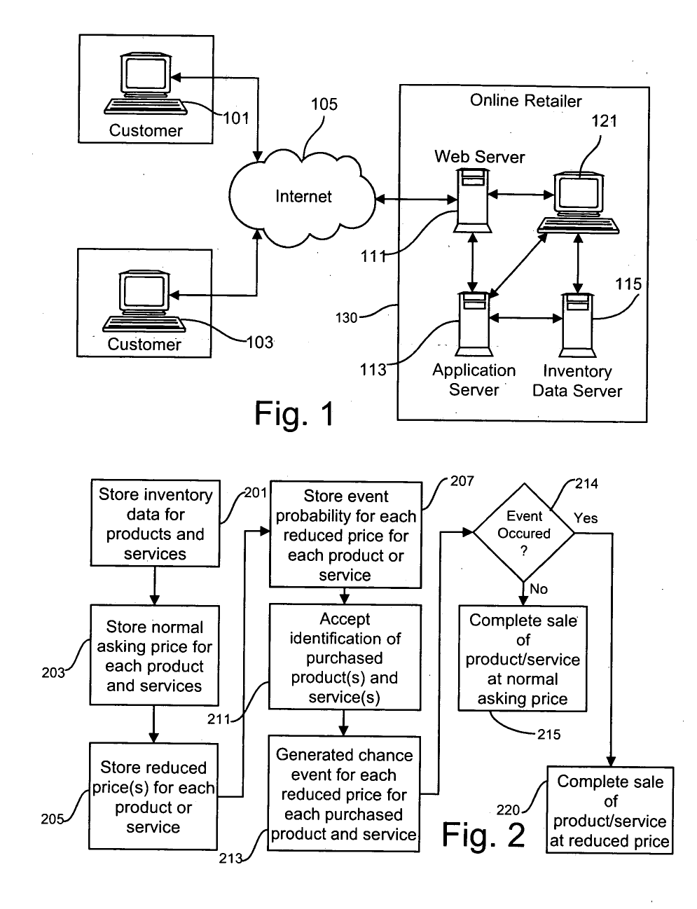

As contemplated by the invention, selected products or services may be offered for sale at a predetermined price with the added sales incentive that, at the time of purchase, some purchasers may receive those products free of charge, or at a substantial discount. The method employed is illustrated in the flow chart presented in FIG. 2. Prior to any sales session, inventory data is stored in the database server 115 in the conventional way as seen at 201. This inventory data typically includes, for each product or service sold, a unique identification number (such as a universal product code) and a description of the product or service, which may include not only descriptive text but also image files depicting the product, promotional materials such product brochures, and the like.

The current asking price for each product is stored in the database as indicated at 203. Using administration procedures, the merchant may make changes to the asking price as needed using the terminal 121 seen in FIG. 1.

At step 205, the merchant may then select some or all of the products or services to be offered with “probabilistic pricing;” that is, to be offered a either the normal asking price stored at step 203 or at one or more reduced prices (one of which is typically zero cost) which will be charged in the event that a predetermined chance event occurs at the time of sale.

At step 207, the merchant then specifies the probability with which the chance event is to occur with respect to each specified reduced price. Thus, the merchant may specify that a bicycle is to be offered at the normal asking price of $319.95, or at half price ($159.97) in the event that one selection process results in a positive outcome, and at no charge ($0.00), if a second selection process results in a positive outcome. At step 207, the merchant may specify that the “half-price” chance event will occur once every ten times, or with the probability of p=0.1, and that the “no charge” chance event will occur once every twenty times, or with the probability of p=0.05.

The purchaser is provided with a full disclosure of the opportunity to receive either a substantial discount or to receive the selected goods or services at no charge, and is further informed of the “odds” of obtaining each discount. Prior to the purchase, the purchaser may be given the opportunity to choose either a guaranteed equivalent discount of 10% or instead “take a chance” in hope of receiving a full or half-price discount. In the example method of FIG. 2, the goods or services that the user has made a commitment to purchase are identified at the time of purchase at 211. A chance event is then evaluated at 213 and 214; for example, a pseudo-random process is executed at 213 to generate a random number and this number is then evaluated at 214 to determine whether or not it satisfies a predetermined criteria. If the event occurs, the sale is completed by charging the purchaser the reduced amount (or permitting the purchaser to obtain the selected goods or services for no charge) as seen at 220. If the event does not occur, the purchaser is charged the normal asking price as seen at 215. If the selection process is based on selecting individual purchasers, the preferred implementation is one in which the selection process [023] is carried out at an earlier step of the process preferably as the purchasers enter the retailer's store or website (before [024]).

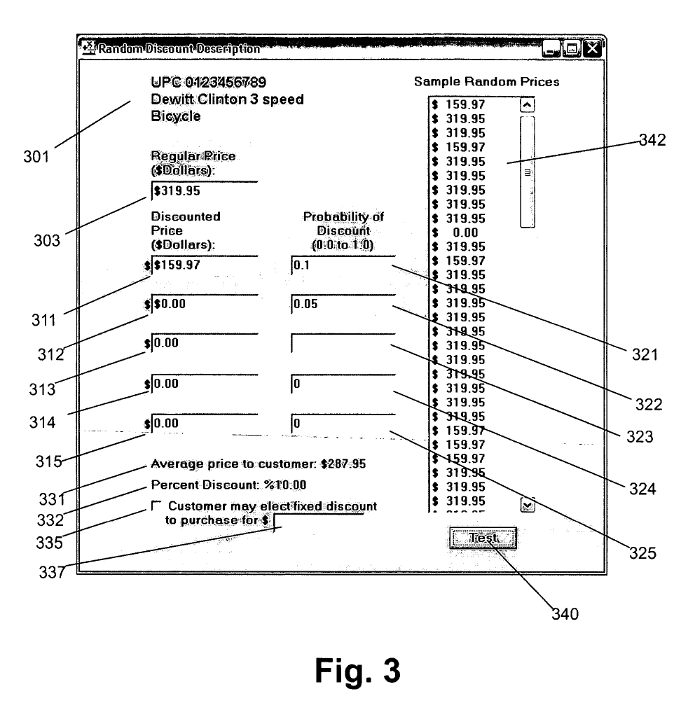

To facilitate the selection of discounts for some or all products, an administrative module in online storefront system 130 may present the merchant with a dialog box of the kind illustrated in FIG. 3. The dialog box is displayed after the merchant has selected a given product of service from the available inventory data, and the description of the product appears at 301 and the current asking price of the product is displayed in an edit box 303. The merchant is given the opportunity to change the current asking price by altering the value displayed in the edit box 303, and to enter zero to five different discounted prices in the edit boxes at 311, 312, 313, 314 and 315. For each discounted price, the merchant can enter the probability at which the discounted price will be charged in the corresponding edit boxes 321, 322, 323, 324, and 325. In the example shown in FIG. 3, the merchant has specified that the product will be sold at the discounted price of $159.97 with a probability of p=0.1 , and the product will be discounted to $0.00 (no charge) with a probability of p=0.05. If there is a zero or no entry in one of the boxes 321-325, any discount specified in the adjacent box 311-515 is ignored [026] Whenever an entry in any of the edit boxes 303-325 is changed, the average price to the purchaser (shown at 331) and the expected average percent discount (shown at 332) is recalculated and redisplayed. In this way, the merchant can see the practical effect of discount. Using the check box at 335, the merchant may designate whether or not the purchaser is to be allowed to choose a fixed discount rather than “take a chance” on potentially receiving the larger discount. The merchant may enter the price to be charged to the purchaser who elects a fixed discount as seen at 337.

To help the merchant visualize and understand the manner in which a sequence of purchasers will be charged using the supplied discount and probability values, the button labeled “Test” at 340 may be pressed, causing a simulation to be executed which will display a sequence of actual prices charged. The simulated charges are listed in the list box 342 as seen in FIG. 3, showing that the first purchaser received a half price discount, the next followed by four purchasers who received no discount, a sixth purchaser received a half-price discount, etc.

The following routines, written in the Pascal programming language, illustrate how a conventional random number generation routine may be used to create pseudo-random chance events that determine whether a discount will be applied to a given sales transaction. In the example below, the merchant supplies the value for the following variables:
rp_value: the regular price entered in edit box 303;
dp1_value, dp2_value, dp3_value, dp4_value, dp5_value: the discounted prices entered in edit boxes 311-315 respectively; and
p1, p2, p3, p4 and p5: the probabilities (expressed as a number from 0.0 to 1.0) as entered in edit boxes 321-325 respectively that each of the discounted prices (dp1_value, dp2_value, dp3_value, dp4_value, dp5_value) will be the outcome of the selection process.

Given these values, the price actually charged to each purchaser is determined by calling the function “random_price” set forth below, which processes the supplied values to obtain a price value based on a sequence of tests in which a random real (floating point) number in the range between 0 and 1 returned by the function “random” is tested to determine if it is less than the probability supplied by the merchant for that discounted price. Thus, if the merchant supplied probability value for p1=0.2 (a one in five chance) and p2=0.1 (a one in ten chance), then the second test “if random<(p2/(1-p1))” in the function below will return true and set the discount to dp2_value one in ten times. Note that p2 is multiplied by the factor 1/(1-p1) to reflect the fact that the test for the second discount is only performed if the test for the first discount returned false. Thus, to achieve an overall probability of p2, the second test must return true with the increased probability of p2/(1-p1).

function tForm1.Random_price: real;
begin

if random < p1 then

begin random_price:= dp1_value; exit end;

if random < (p2 / (1-p1)) then

begin random_price:= dp2_value; exit end;

if random < (p3 / (1 - p1 -p2)) then

begin random_price:= dp3_value; exit end;

if random < (p4 / (1 - p1 - p2 - p3)) then

begin random_price:= dp4_value; exit end;

if random < (p5 / (1 - p1 - p2 -p3 - p4))then

begin random_price:= dp5_value; exit end;

random_price:=rp_value

end;

The library function “random” produces a pseudo-random value between 0 and 1.0. The comparison between the computer-generated random number and the probability criteria specified by the merchant is repeated for each discount value supplied by the merchant and, if the chance event occurs (i.e., random returns a value less than the probability at which the associated discount is to be applied), the purchaser is charged that discounted amount. If the specified chance event does not occurs for any of the discount values, the random_price function returns the regular asking price, rp_value.

Other mechanisms may be used to create a chance event that determines when a stated discount (or free purchase) is applied. A purchaser may be assigned a random number upon entering the store, and the purchaser's number may be selected in advance of the actual purchase, enabling the system to announce that “Five purchasers already in the store have already been selected to get their purchases free.”

Although the mechanism described above permits the merchant to set any discount price and associated probability that might be desired, it is preferable to offer a certain (relatively low) probability of paying nothing (zero price); that is, to give the purchaser the chance to pay nothing at all. Moreover, in an environment in which the purchaser may purchase many items, such as in a grocery store or a drug store, it is advantageous to give the purchaser the opportunity to get the entire shopping basket of selected goods for free. The idea is that “free” is perceived to be very different from a mere discount, and that the probability of “getting something for nothing” creates a very different feeling from paying a reduced price. Getting something for free creates a uniquely pleasurable experience, the chance of obtaining goods and services for nothing evokes feelings of excitement, challenge, competition, fun, and entertainment, leading potential purchasers to spend a more money in order to “win.”

The present invention thus provides a greater sales incentive than an equivalent fixed discount. A fixed, guaranteed discount of 1% for each purchaser offers little sales incentive compared with a 1% probability of getting an entire shopping basket for free, although both have the same expected promotional cost for retailers. The use of the invention can be expected to produce:
a) more purchases (a larger basket size);
b) an increased proportion of higher-cost items;
c) an increased proportion of impulse purchases;
d) higher closure rates;
e) increased purchaser loyalty;
f) more frequent purchasing;
g) more new purchasers; and
h) lower return rate of purchased items since participating purchasers agree in advance not to return items purchased

The methods and apparatus embodying the invention preferably have the following characteristics:

Immediate reward: In many cases individuals are impatient and typically prefer an immediate reward to a reward in the future, even in cases where the immediate reward is lower. Probabilistic purchasing offers the chance for an immediate “free” purchase at the time of checkout, which should be much more preferred compared to delayed rewards (such as discounts from next purchase or points);

Knowledge about the system while shopping: For the system to work most effectively it is important that the shopper is informed in advance that the system is in place. In fact, as noted above, winners may be assigned numbers as they enter the store and be told that “you might have already been selected to be a winner.”

Knowledge about others in the system: because this system is probabilistic, many individuals will not win and thus it is important to give them indications of others who are winning. An ideal system will indicate whenever someone wins in real time. This is similar to the effect on Las Vegas when the slots machines announce loudly when someone wins. As an example in the offline retail environment (“bricks and mortar”), a flashing light and a bell could be positioned at every checkout station, and the purchaser checking out when the light and bell are activated at a randomly selected time would receive the discount.

Returns: because of the structure of the promotion, individuals should not be allowed to return the products (otherwise they can try again and again and again . . . ). Instead individuals should be alerted (maybe at checkout) that participating in this process requires that they will not return the products. Discouraging returns thus provides a valuable side-effect to the merchant;

Scope: This type of promotion can apply to everything in the store or to selected products. For example in the travel industry it might be beneficial to promote with this approach a few selected destinations. Similarly, a shoe store might want to promote a few items this way. In these cases only the selected items will be eligible for the probabilistic purchase.

The random process employed (i.e., every X person, every Y time, or by some independent random event ) will preferably be described in advance to potential purchasers. The discount size, preferably to zero cost, will be noted. Purchasers can be given the opportunity to opt out or get a different type of discount, preferably being given this choice at the time of checking out. The probability with which discounts are applied to individuals will be selected at a probability declared in advance to determine if they will get the discount or not.

In one preferred method, the purchasers who are to receive a discount are selected prior to check out, and are advised that they might have been selected to get their entire basket for free or at a substantial discount. At the checkout time the purchaser will agree to the conditions of the probabilistic purchasing (which might include penalty for returning merchandise), and once the payment is approved, the purchaser will be notified if they qualify for the discount. If the purchaser qualifies, the payment will not be charged to them (or immediately returned). It is also preferable to provide current shoppers with information about other current or recent winners, confirming that success is possible and increasing excitement.

Conclusion

It is to be understood that the methods and apparatus, which have been described above are merely illustrative applications of the principles of the invention. Numerous modifications may be made by those skilled in the area without departing from the true spirit and scope of the invention.

1. The method of promoting a product or service comprising offering said product or service for sale either at first predetermined normal price or at a second predetermined reduced price if a chance event with a known probability occurs at the time of sale.

2. The method of promoting a product or service as set forth in claim 1 wherein said reduced price is zero.

3. The method of promoting a product or service as set forth in claim 2 wherein the occurrence of said chance event is determined by generating a random or pseudo-random number and determining whether or not said number satisfies a specified criteria.

4. The method of promoting a product or service as set forth in claim 1 wherein said step of offering said product or service for sale is followed by the further steps of:
receiving an acceptance of said offer by a purchaser,
performing a random or pseudo-random process to produce said chance event with said known probability, and
accepting from said purchaser a payment of said normal price if said chance event does not occur or accepting a payment of said reduced price if said chance event does occur.

5. The method of promoting a product or service as set forth in claim 4 wherein said reduced price is zero.

6. The method of promoting a product or service as set forth in claim 1 wherein the probability of occurrence of said chance event is preset by the seller.

7. The method of promoting a product or service as set forth in claim 6 wherein said probability of occurrence is included in the information provided to said purchaser prior to the time of sale.

8. The method of promoting a product or service as set forth in claim 1 wherein a purchaser is given the opportunity at the time of sale to elect to receive a predetermined discount rather than at said reduced price if said chance event occurs.

9. The method of promoting a product or service comprising offering said product or service for sale at first predetermined normal price or alternatively providing said product or service at no cost to the purchaser if a chance event occurs that is expected to occur only with a predetermined probability said product is sold.

10. The method of promoting a product or service as set forth in claim 9 wherein each purchaser that receives said product or service at no cost is selected by said chance event which occurs prior to the time said purchaser elects to purchase said product or service and wherein purchasers are advised prior to making any purchase that they may have been selected to receive said product or service at no cost.

11. The method of promoting products or services comprising offering said products or services for sale at stated prices or alternatively providing products or services selected for purchase by the purchaser at no cost to the purchaser if a chance event occurs at the time of sale that is expected to occur only with a predetermined probability when products or services are sold.

12. The method of promoting products or services as set forth in claim 11 wherein the probability of occurrence of said chance event is preset by the seller.

13. The method of promoting products or services as set forth in claim 12 wherein said probability of occurrence is included in the information provided to said purchaser prior to the time of sale.

14. Apparatus for executing the sale of goods or services comprising, in combination,
means for storing the normal sale price of said goods or services,
means for storing a control value that specifies the probability with which a chance event will occur when a random event generation process is performed,
means for performing said random event generation process at or before the time when identified goods or services are being purchased by a purchaser, and
means for presenting a request for payment from said purchaser at either said normal sale price of said identified goods or services if said chance event does not occur and at a reduced sale price if said random event does occur.

15. Apparatus for executing the sale of goods or services as set forth in claim 14 wherein said reduced price is zero.

16. Apparatus for executing the sale of goods or services as set forth in claim 14 including means for accepting and storing said reduced sale price of said goods prior to the time when said identified goods or services are being purchased by said purchaser.

17. Apparatus for executing the sale of goods or services as set forth in claim 14 wherein said random event generation process is performed prior to said time when said identified goods are purchased to randomly select individual purchasers who are to be charged said reduced sale price.

18. The method of promoting products or services comprising offering said products or services for sale at stated prices or alternatively providing products or services selected for purchase by the purchaser at reduced prices to the purchaser when chance events occurs at the time of sale that are expected to occur only with a predetermined probability when products or services are sold.

19. The method of promoting products or services as set forth in claim 18 wherein said stated prices and said reduced prices are included in the information provided to the purchaser prior to said time of sale.

20. The method of promoting products or services as set forth in claim 19 wherein the probability at which said chance events are expected to occur is included in the information provided to the purchaser at the time of sale.
